(19) United States
(12) Patent Application Publication
(10) Pub. No.: US 2014/0321586 A1
(43) Pub. Date: Oct. 30, 2014

(54) SYSTEM FOR HIGH-CLOCK SYNCHRONIZATION AND STABILITY

(71) Applicant: Greina Technologies, Inc., Salt Lake City, UT (US)

(72) Inventors: Daniel Joseph Lee, Salt Lake City, UT (US); Thomas Schmid, Salt Lake City, UT (US)

(73) Assignee: Greina Technologies, Inc., Salt Lake City, UT (US)

(21) Appl. No.: 14/265,087

(22) Filed: Apr. 29, 2014

Related U.S. Application Data
(60) Provisional application No. 61/817,140, filed on Apr. 29, 2013.

(51) Int. Cl. H04L 7/00

(52) U.S. Cl. CPC H04L 7/0037
USPC 375/362

(57) ABSTRACT

Systems and methods for high-clock synchronization and stability are disclosed.

### CROSS-REFERENCE TO RELATED APPLICATIONS

This application claims the benefit of U.S. Provisional Application Ser. No. 61/817,140, filed Apr. 29, 2013 and entitled SYSTEM FOR HIGH-CLOCK SYNCHRONIZATION AND STABILITY, which application is incorporated by reference in its entirety.

### BACKGROUND OF THE INVENTION

1. The Field of the Invention

Embodiments of the invention relate to systems and methods for synchronizing two or more oscillators. More particularly, embodiments of the invention relate to systems and methods for achieving high-precision clock synchronization of two or more oscillators in two or more devices.

2. The Relevant Technology

In some instances, a system may require two local oscillators that are frequency and phase coherent. For example, a system that tries to measure the distance between two radio transceivers may need two local oscillators that are frequency and phase coherent. Many conventional synchronization systems use digital counters and timers to achieve synchronicity of multiple cycles of a clock or an oscillator. This may have been achieved conventionally using a phase-delay unit to adjust for phase delays.

However, such systems are often unable to achieve high synchronicity of multiple cycles. Systems and methods for achieving high-precision clock synchronization are needed.

### BRIEF DESCRIPTION OF THE DRAWINGS

FIG. 1 illustrates an example of a hardware flow for controlling a local oscillator and synchronizing with an incoming signal.

FIG. 2 illustrates an example of a method for adjusting a phase of a signal.

FIG. 3 illustrates another example of a routine method for adjusting a phase of a signal independently of its frequency.

FIG. 4 illustrates an example of a method for generating a signal when a phase of the signal is adjusted independently of its frequency.

### DETAILED DESCRIPTION OF THE PREFERRED EMBODIMENTS

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Embodiments of the invention include a combination of controllable crystal oscillators and a Bolus Software Algorithm that injects energy into the oscillator that, in one example, will only adjust the phase of the oscillator, but not its frequency. As a result, the frequency synchronization can be separated from the phase synchronization. In addition, both operations can be performed using just one hardware unit.

Embodiments achieve ultra-high oscillator synchronization of two devices that can communicate. The systems and methods include hardware designs, as well as software algorithms that cooperate with the hardware to achieve ultra-high oscillator synchronization. For example, one device (e.g., a node such as a transceiver or transmitter/receiver or a radio that is a master device) may transmit one or more narrow-band radio signals at a higher frequency than a local oscillator of the device. This is achieved using a phase-locked loop (PLL) and voltage controlled oscillator (VCO) (which is an example of an oscillator or an oscillator unit) inside the device. This higher frequency signal is sent to a second device, which tunes its radio using its PLL and VCO close to that same frequency. Due to differences in the environment and the physical oscillator, their frequencies may be different. The second device then adjusts its controllable high-stability local oscillator to the incoming signal, thus achieving an ultra-high synchronized system.

The higher frequency helps in adjusting the local oscillator with a higher precision, as we can employ a lower-resolution phase measurement at the higher frequency, and relate it to the lower frequency clock crystal due to the use of PLLs.

For example, assume a low-frequency of 16 MHz, and a high-frequency of 2.4 GHz. This gives a multiply of 150. If the second device or node uses the 2.4 GHz signal to tune its local 16 MHz signal to achieve phase coherency with the 16 MHz signal of the first device or node, then a low-resolution phase measurement unit (PMU) at the 2.4 GHz signal is enough to achieve extremely high synchronization stability. For example, assume it is necessary to correct for a 10 degree phase error at the 2.4 GHz signal every 15 ms. This corresponds to an absolute synchronization stability of the lower frequency oscillator of 10/150=1/15 degree correction every 15 ms, or 4.4 degrees error per second (0.012222 Hz). This equals a synchronization stability of 764 parts-per-trillion.

Embodiments of the invention include the control of the local oscillator, based on the measured difference at the high-frequency signal between the incoming and locally generated signals. To achieve clock synchronization of below-one cycle synchronization, it may be necessary to use phase measurement units and a tunable crystal oscillator. This higher stability is necessary for high-precision ranging systems (e.g. U.S. Pat. No. 8,274,426, which is incorporated by reference in its entirety).

Embodiments of the invention include a combination of crystal oscillators (e.g., analog temperature compensated crystal oscillators (A-TCXO) such as, by way of example only, a Citizen CSX532T or QuartzCom VT7-503M) and a method that injects energy into the oscillator in a manner that allows only the phase to be adjusted without adjusting its frequency. However, even though the phase may be adjusted, the frequency may be temporarily changed. The frequency and phase can be adjusted independently.

Embodiments of the invention disclose a novel approach for achieving ultra-high oscillator synchronization of two devices that can communicate. Embodiments of the invention relate to the local oscillator and control of the local oscillator, based on the measured difference at the high-frequency signal between the incoming and locally generated signals.

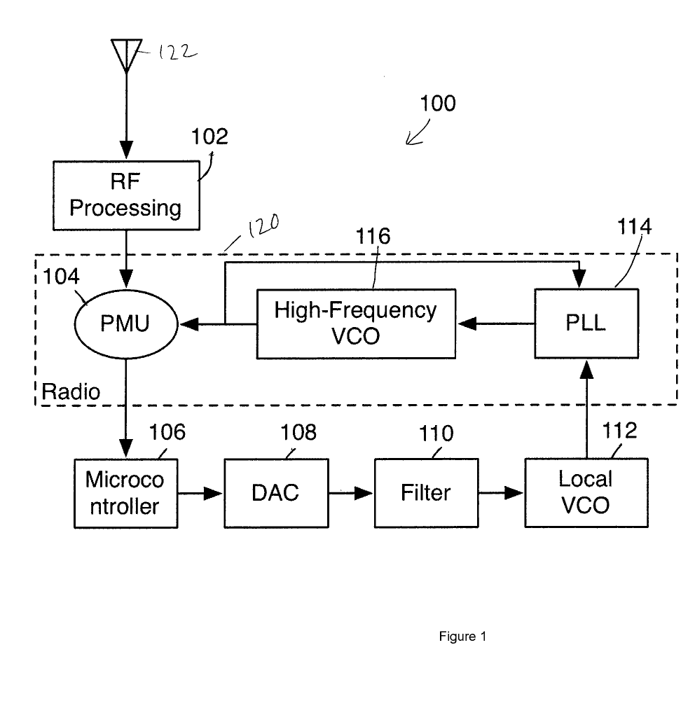

FIG. 1 illustrates hardware and a flow of the hardware in the context of synchronizing a device with an incoming radio signal. FIG. 1 illustrates hardware included in a device 100 such as a radio 120 that can receive and/or transmit electromagnetic signals. The radio may have one or more antennas or be capable of communicating using one or more antennas. The radio 120 may also be capable of transmitting and/or receiving over one or more frequencies over one or more antennas. Each device 100 may be a node in a system that includes multiple devices. In such a system, each node or device may be capable of establishing independent communication with each of the other nodes.

FIG. 1 illustrates an example of the overall system hardware architecture. Generally, an incoming high-frequency signal is compared to the local high-frequency signal, and the phase-difference is measured over time. A microcontroller (MCU) or other digital circuitry (e.g., a controller or processor) adjusts a digital to analog converter (DAC) to change the local oscillator (OSC) until its generated local high-frequency signal (through PLL) matches the incoming signal. The microcontroller or controller may perform these functions in two steps. First, the microcontroller adjusts for frequency error by setting the DAC's absolute value close to the incoming frequency. Then the microcontroller injects or extracts small amounts of energy to achieve phase coherency. The second adjustments are made through a software algorithm, called Bolus, which injects small amounts of energy that changes the phase, but not the frequency, of the local oscillator.

More specifically, in FIG. 1, an incoming high-frequency signal (sent by another node) is received by an antenna 122 of a radio 120 and is compared to the local high-frequency signal usually generated using the high-frequency VCO 116 of the device 100. The phase-difference is measured over time in a phase measurement unit (PMU) 104. A microcontroller 106 adjusts a digital to analog converter (DAC) 108 to change the local voltage-controlled oscillator (VCO) 112 until its generated local high-frequency signal (through a PLL 114) and high-frequency VCO 116 matches the incoming signal on the radio 102. The adjustments are made through a software method (e.g., by a the microcontroller 106 which executes code stored in a memory) which injects small amounts of energy that changes the phase, but not the frequency, of the local VCO 112. An optional analog low-pass filter 110 cleans up the analog output of the DAC, in order to provide a highly-stable analog signal to the VCO, and to reduce potential noise.

FIG. 1 illustrates that the PMU 104 can compare an incoming high frequency signal from another radio with the high frequency signal generated by the radio 120. By adjusting the phase of the high-frequency signal generated by the radio 120 as described herein, high-precision clock synchronization of two or more oscillators in two or more devices can be achieved.

In addition, by synchronizing the VCO 112 with the incoming signal 102, this enables the radio 120 to effectively reflect a signal back to the radio that sent the incoming signal 102. Advantageously, this allows the signal to be used, for example, to perform high-accuracy ranging.

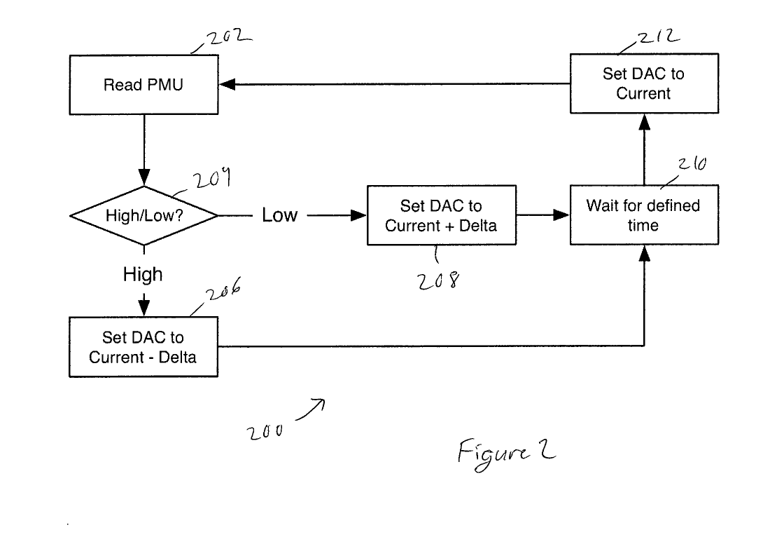

FIG. 2 illustrates an example of a method or routine for adjusting a phase of a signal. The routine 200 adjusts the phase, but not the frequency, of a local voltage controlled oscillator 112 by injecting short bursts of energy into a control pin through manipulating a digital to analog converter (DAC). If the measured phase measurement unit (PMU) shows a low value, the DAC is set to the current value plus a predefined delta voltage for a certain amount of time lambda_{—}1, and if it is high, the DAC gets set to the current value minus a predefined delta voltage for another time lambda_{—}2. The delta voltage and time define the amount of energy injected and can be adjusted for either fast injection (higher delta, smaller time) or slower adjustment (lower delta, longer time). By changing either the time, or delta, different amounts of energy can be injected, thus adjusting for bigger PMU measurement differences.

More specifically, the method or routine 200 begins by reading a PMU in box 202. The reading may be a comparison between the phase of an incoming signal and a phase of a similar signal generated locally in a device to determine how the phases differ. A determination is then made to determine if the reading is high or low in box 204 (e.g., how the phase is out of sync). If the reading is low, the DAC is set to the current value plus a delta in box 208. If the reading is high, the DAC is set to the current value minus the delta in box 206. After waiting a defined time period in box 210 (after adjusting the DAC by plus or minus delta), the DAC is set back in box 212 to the value before the routine started to obtain the same frequency, and the method begins again by reading the PMU in box 202.

Advantageously, the routine for adjusting the phase makes frequency and phase correction independent of each other. This is advantageous in frequency hopping or low-power networks, where one retunes the radio frontend for different frequencies, or one turns the radio on and off to save energy. In that case, one does not want to change the frequency of the oscillator, but just adjust for the change in phase that gets incurred by changing the radio frontend.

In one example, FIG. 2 depicts a software algorithm for a Bolus routine. The bolus routine adjusts the phase, but not the frequency, of a local oscillator by injecting or extracting short bursts of energy into the control pin through manipulating a digital to analog converter (DAC) as previously described.

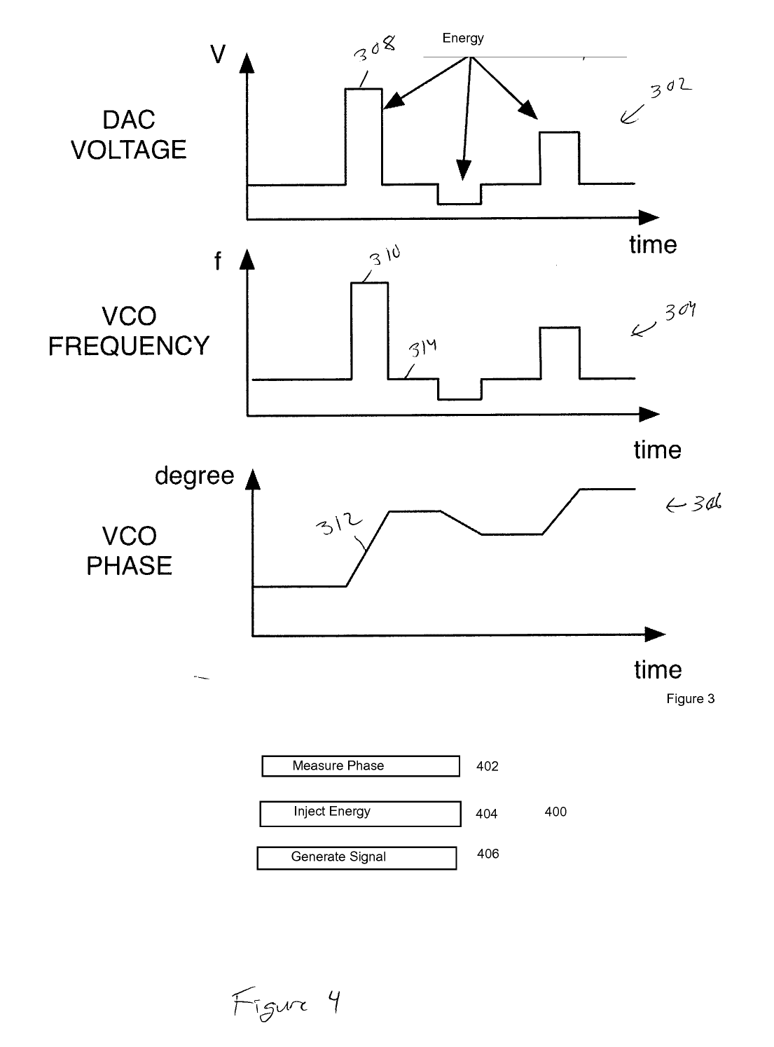

FIG. 3 illustrates another example of a method or routine for adjusting or changing a phase of a signal. During the method, the VCO frequency may increase, or decrease, depending on the control voltage output by the DAC. In one example, the frequency drops back down to a normal level, after the routine is executed. Thus, only the phase of the VCO changes by a pre-determined amount (even if the frequency changes for a short time) and the pre-determined amount can be calculated by the voltage increase and duration of the energy applied to the control pin of the DAC.

FIG. 3 illustrates a plot 302 of DAC voltage over time, a plot 304 of the VCO frequency over time, and a plot 306 of a VCO phase over time. FIG. 3 illustrates, for example, that when a energy (e.g., a voltage) 308 is applied, the VCO frequency has a corresponding increase 310. The energy applied can be of a predetermined magnitude and/or duration. However, the VCO frequency returns to normal at 314 after the energy 208 is over or after the voltage returns to a previous or different level. However, an increase 312 in phase is achieved that remains. Consequently, the phase of the local signal can be adjusted independently of the frequency and can be changed to match the phase of the incoming signal. During a Bolus, the VCO frequency increases, or decreases, depending on the control voltage output by the DAC. However, the frequency drops back down to normal level, after the Bolus is executed. Thus, only the Phase of the VCO changes by a pre-determined amount, which can be determined by the voltage increase and the duration of the Bolus or of the energy injection or extraction.

Embodiments of the invention can be further enhanced by counting the number of positive or negative boluses that are executed. If several positive boluses are used in a row, this suggests that the frequency of the two oscillators are slightly off. Thus, the algorithm can decide to perform an absolute frequency adjustment by increasing the base value by a small amount, while executing the bolus. For example, the bolus routine increases the DAC by lambda_{—}1, and after the predefined time instead of returning to the original value, it will return to the original value plus a delta value. The size of this delta value can be calculated by the number of times that the previous positive bolus was executed, and the length and intensity settings of the previous boluses. The same operations can be done with negative boluses, just the other way around (i.e. the DAC is returned to the current value minus a delta value).

The type of VCO for this system to achieve ultra-high synchronization stability may be configured to have certain characteristics. The VCO should not exhibit significant frequency or phase jumps due to changes in its environment. For example, many digitally controlled temperature compensated crystal oscillators (DCTCXO) exhibit phase discontinuities or phase jumps when the digital circuit decides that the change in temperature requires an adjustment in frequency. While these discontinuities are not large, they can be too big to keep a high-precision system accurate, especially if those changes happen during synchronization. Thus, such DCTCXOs may need a freeze function to tell them not to adjust for changes in temperature, while synchronization is happening, or the DCTCXO would have to inform the system and other adjustments could be made.

Analog compensated temperature controlled crystal oscillators (ACTCXO) on the other hand exhibit a smooth change for change in temperature. This is ideal, as embodiments of the invention can adjust for these smooth changes, keeping the system tightly synchronized.

One of skill in the art can appreciate that ACTCXOs or other components from other manufacturers, as well as new MEMS resonator based oscillators, may also be used in embodiments of the invention.

The bolus routines or methods can also be applied in paused or double-clocked discontinuous phase locked loops, where the loop time is variable. The bolus adjust can be used to shift the phase, where a simple voltage change may over or under shoot with variable sample time.

FIG. 4 illustrates an example for adjusting an oscillator. The method begins by measuring a phase in box 402. This can include comparing a phase of an incoming signal with a phase of a locally generated signal and determining how the phase should be adjusted locally in order to match the phase of the incoming signal. In box 404, energy is injected into the system in a manner that alters the phase of the locally generated signal. The energy may be a voltage and/or current. For example, a voltage applied to a control pin of a VCO may be increased or decreased by a certain amount for a certain amount of time. This results in a phase change, but does not permanently alter the frequency. This process can be repeated continually during operation of the device to maintain high-precision clock synchronization of two or more oscillators in two or more devices. The generated signal may be transmitted back to the device that generated the original incoming signal.

The method for adjusting a phase can be an iterative process that may be performed repeatedly over time. In one example, the local oscillators are continually adjusted as long as two communicating devices are operating. The method may include changing or hopping frequencies as well such that the two devices transmit/receive more than one frequencies. In one example, the frequency for which adjustments are made may also be changed in addition to changing the phase. The devices may be configured such that the various frequencies can be transmitted at the same time or at separate times.

Embodiments relate to ranging systems, including integrated ranging systems, which are capable of providing precise measurements with minimal bandwidth utilization. Embodiments provide an active-reflector, or transponder-type radio frequency ranging system in which phase and frequency coherency between master and slave devices can be precisely established during periods when measurement data is generated.

Embodiments enable discontinuous transmissions on multiple frequencies in order to optimize the use of available bandwidth, and to avoid channels which are either being used for unrelated transmissions or beset with noise.

Embodiments may provide a system of vernier measurement, whereby distances are measures in terms of an integer number of wavelengths plus a fraction of a wavelength that is determined by phase angle differences between two transmissions at different frequencies. Embodiments eliminate multi-path data from ranging calculations in some examples.

A high-resolution active reflector radio frequency ranging system includes at least two radio frequency transceivers (e.g., devices or nodes) in one example. One of the transceivers, acting as a master device, transmits a radio frequency signal burst to at least one other designated transceiver which acts as a slave device and active reflector. The slave device, actively matches the phase and frequency of the incoming signal and retransmits a signal at the matched phase and frequency. The slave can retain the phase and frequency data that it receives for some time before retransmitting the signal to the master. Within a network, master and slave designations are arbitrary, as those roles can be temporarily assigned as required. In fact, any device that initiates a ranging operation may be a master device. Each transceiver device, or node, may be assigned a unique address. As the system supports a master with multiple slaves, point-to-point ranging, as well as point-to-multipoint ranging are enabled.

Operation of the high-resolution active reflector radio frequency ranging system will now be described. A first device (the acting master) transmits a radio signal burst asking for a ranging measurement. A second device (the acting slave) determines, either by default or by decoding a read range data packet, that it is the device from which the acting master is requesting the ranging measurement. Following a positive determination, the acting slave device measures phase and/or frequency drift of the incoming carrier wave and aligns its own oscillator, or clock, so as to achieve commonality of frequency and phase coherence with the incoming signal. Accuracy of oscillator alignment within the slave unit can be enhanced by transmitting multiple packets. The slave extracts phase and frequency data from each packet or determines the phase and frequency data using a phase information unit and averages the results in one example. The more packets that are received over time, the more accurate the calculation of the phase and frequency of the incoming carrier and the readjusting of the slave's internal clock or oscillator.

For an embodiment of the invention, an adaptive loop is employed to measure the phase of random incoming packets from the master and adjust the slave unit's oscillator so that it is phase coherent with the master unit's oscillator. No continuous wave transmission is required. In fact, the incoming RF signal can transmit multiple packets over multiple frequencies during different periods of time. The preferred embodiment of the invention may also incorporate a delta sigma phase lock loop, which maintains phase coherency of the of the slave unit's oscillator with the incoming signal, regardless of its frequency. Software onboard the slave unit is used to process incoming signal information and reconstruct it in order to maintain phase lock of the slave unit's oscillator with that of the master. This feature facilitates the implementation of frequency hopping, which is used in determining measurement of absolute distances between master and slave units.

One embodiment employs thermally-insulated reference oscillators, which need be neither highly stable over time, nor highly accurate at a rated temperature. However, the thermally-insulated oscillators are very stable over short periods of time commensurate with the periods required either by the master unit to send a burst signal and receive a burst signal in response, or for a slave unit to receive, analyze, and retransmit a signal burst. A thermally-insulated quartz crystal oscillator can be fabricated by encapsulating the oscillator within an Aerogel® insulation layer. Aerogel is an ideal insulator for the application, as it has a coefficient of expansion that is virtually identical to that of quartz. Thus, in the case of a slave unit, its thermally-insulated reference oscillator is adjusted in frequency and phase to match those corresponding characteristics of the carrier wave received from the master unit, and the signal is retransmitted to the master. This process occurs over such a short period of time that any frequency drift in the thermally-insulated reference oscillator is negligible. A thermally-insulated reference oscillator (TIRO) has an advantage over an ovenized oscillator in terms of both cost and energy consumption. For battery powered devices, ovenized oscillators are highly impractical, as they must remain heated even when not in actual use in order to maintain stability. A 16 MHz thermally-insulated reference oscillator developed for the prototype high-resolution active reflector radio frequency ranging system has exhibited drift characteristics of less than 2.5 parts per 10 billion over a period of one second. Using this type of reference oscillator, the system is capable of ranging accuracies of better than 0.125 mm.

When the master unit transmits a radio frequency burst at a particular frequency to a slave unit, the signal is received by the slave unit, mixed with at least one local oscillator signal to create an error signal, which is fed to a digital control system consisting of a central processing unit or state machine. The output from the digital control system is fed to the reference oscillator, which controls the delta sigma phase lock loop, which in turn, controls the local oscillator. Because the individual bursts may be too short to generate an accurate determination of phase and frequency error, several bursts may be required to achieve optimum lock-on of the slave unit's reference oscillator. Thus, the TIRO retains the incoming phase and frequency information so that no matter on which channel the phase lock loop (PLL) is initially set, it derives its phase information from the reference oscillator. Thus, as the TIRO sets the phase and frequency of the PLL, the TIRO also effectively sets the frequency of the slave unit's transmitter and local oscillator.

There are two major problems associated with divide-by-integer phase lock loops. The first is that if sufficient bandwidth is allocated to the low-pass filter for a required modulation range, there is insufficient step resolution for both frequency generation and frequency modulation. The second is that if smaller frequency steps are utilized, there is insufficient band width at the low-pass filter. Fractional phase lock loops (also known as delta sigma phase lock loops) were developed to solve precisely these problems. For example, in one embodiment of the invention, the fractional PLL generates 64 clock cycle phase relations (diffs) of the local oscillator for each cycle of the 16 Mhz reference oscillator. However, when a fractional PLL is used, the wave form edges of the generated signal may not directly align with the reference oscillator. This is especially problematic in a ranging system where synchronicity of phase relationship between transmitted and received signals is essential for meaningful distance measurements. In addition, if burst-mode operation or frequency-hopping is envisioned, or if the local oscillator—for the sake of circuit simplicity and minimal power consumption—is shared between transmit and receive functions, it is essential that the phase relationship between the transmitted and the received signal be establishable at all times. Embodiments may employ a phase relationship counter, which keeps track of the fractional time frames of the fractional phase lock loop as a function of the reference oscillator. The phase relationship counter provides absolute phase information for an incoming burst on any channel within the broadcast/receive band, thereby enabling the system to almost instantaneously establish or reestablish the phase relationship of the local oscillator so that it synchronized with the reference oscillator. The phase relationship counter, coupled with the thermally-insulated reference oscillator that ensures synchronicity of master and slave reference oscillators with negligible drift over short periods of time, allows the system to: minimize power consumption by cutting power to all but the reference oscillator and phase-relationship counter when it is not receiving or transmitting signals; utilize a common voltage-controlled local oscillator for both receive and transmit operations; and maintain predictable phase relationships between the local oscillator and the received signal for both discontinuous bursts at the same frequency and bursts at different frequencies (frequency hopping). Frequency hopping greatly enhances the usefulness of the system, as noisy channels can be avoided and the presence of multipath transmissions can be detected and eliminated from ranging calculations. Frequency hopping can be used with any radio technology where adequate bandwidth is provided.

The radio transceivers used to implement embodiments may employ quadrature phase modulation (QPM) Like all modulation schemes, QPM conveys data by changing some aspect of a carrier signal, or the carrier wave, (usually a sinusoid) in response to a data signal. In the case of QPM, the phase of the carrier is modulated to represent the data signal. Although the invention can be implemented by calculating the phase shift of incoming data packets, it can also be implemented by demodulating the phase shift of the QPM data packets and using the resulting data to calculate range.

Vernier measurement techniques can be employed to enhance the accuracy of distance calculations for the present invention. Although vernier measurement has been used in FM radar systems, those systems typically relied on the simultaneous transmission to two or three signals at different frequencies. Embodiments, on the other hand, are unique in that vernier measurement can be implemented using randomly-selected frequencies within randomly-selected channels, which are transmitted during randomly-selected time intervals. This is because the phase relationship counter associated with the slave unit's fractional phase lock loop allows the phase relationship of any received signal to be established as a function of the slave reference oscillator which, for relatively short periods of time, can be considered synchronous with the master reference oscillator. Vernier measurements are made in the following manner: At least two signals, which are in phase at the point of transmission, are transmitted on different frequencies. A course measurement of distance can be made by measuring the phase difference between the signals. Two frequencies suffice if they will not share a common null point over the measured distance. For two-signal measurement, the bandwidth required depends on how accurately phase difference between the two signals can be measured. If measurement accuracy is 3 degrees, then bandwidth can be 0.833 percent of a 400 MHz band, which is a 3.33 MHz-wide band, or two channels that are 3.33 MHz apart. If measurement accuracy is 1 degree, then bandwidth can be 0.277 percent, or 1.11 MHz of the same band. Vernier ranging can be easily implemented on the band specified for wireless personal area network (WPAN) in North America under IEEE specification 802.15.4-2006, as it provides for thirty channels within a bandwidth of 902-928 MHz. If resolution of the receiver is less than 1 wavelength, phase of a received signal can be measured. A coarse measurement provides the number of wavelengths from the transmitter. By calculating absolute phase of the received signals, a fraction of a wavelength can then be added to the number of wavelengths from the transmitter for a more accurate calculation of range. In accordance with the present invention, it is possible to build a radio which can resolve the phase of received signals down to as little as 0.1 degree. With such a radio, phase differences between two adjacent frequencies within a narrow band can be easily resolved. In a band having a wavelength of 12 cm, theoretical resolution for ranging measurements can be better than 0.005 cm.

As previously stated, two frequencies can be used for ranging calculations up to a distance where the first null point occurs (i.e., both frequencies once again are momentarily in phase with one another. Two radio signals at different frequencies will, at some distance from the source, eventually null each other out, thereby making measurements beyond that point ambiguous. Thus, at least three frequencies are required to avoid ambiguous measurements. It is particularly helpful if the third frequency and one of the other two frequencies do not possess a divide by n relationship. Because the ranging system of the present invention utilizes a fractional phase lock loop with a phase relationship counter, random frequency hopping can be employed. When operating in the 902-928 MHz band, for example, the present invention can randomly employ any three or more of the 30 channels over time.

A major advantage of the present invention is that it addresses ranging inaccuracies caused by multipath transmissions. Although a multi-frequency ranging system works well if transmissions are made through a conductor or with a laser, a radio transmission through space generally results in reflections of the transmitted wave front, resulting in multipath transmission paths. As any path other than a straight line between the transmission and reception points is necessarily of greater distance, the signal which provides the correct phase shift for accurate ranging will be accompanied by signals that have traveled greater distances and which, therefore, display increased amounts of phase shift. The ranging systems constructed in accordance with the present invention transmit at least three radio signals at different frequencies and compare the distance-phase relationship between the different frequencies. The ranging system of the present invention utilizes a frequency-hopping approach to identify multipaths, select the shortest path, and calculate the distance of the shortest path. This is uniquely accomplished by constructing a table of measured phase and amplitude vs. frequency for at least three frequencies, which can be randomly selected in order both to avoid noisy channels and utilize only a small portion of available bandwidth at a given time. An analog-to-digital converter inputs phase-amplitude data into the table in frequency order. This data is subjected to a Fourier transform, preferably using a computer system to perform the calculations. The resulting beat-frequency peaks correspond to the various detected paths. The path having the lowest beat frequency is the shortest and actual distance between the system master and slave units. Using digital signal processing, if an inverse fourier transform is performed on the fourier transform data, the inverse fourier transform data can be used to calculate changes in the phase relationships for different frequencies, and correct for distortion caused by multiple reflective paths as the master and slave units move with respect to one another.

Vernier distance measurement and multi-path detection and correction work in concert. The process is performed using the following sequence of steps. Firstly, using frequency hopping involving at least frequencies f1, f2 and f3, phase differences between the various frequency pairs (i.e., between f1 and f2, f1 and f3, and f2 and f3) are determined. Secondly, multipath correction is performed to eliminate multipath data and determine the integer number of wavelengths at one of those frequencies that separate the master and slave unit antennas for the shortest path. Thirdly, the system switches to a phase accumulation mode and calculates the absolute phase of each received frequency, thereby providing data for calculation of a partial wavelength that must be added to the integer number of wavelengths distance for an accurate measurement. Thus, the ranging system for the present invention provides high resolution range measurements with low bandwidth utilization. Although the transmission of multiple frequencies is required for the initial distance calculation, as long as the object doesn't move more than one-half wavelength between measurement calculations, it can be tracked with a single frequency. In a gaming system, for example, the use of a single frequency between antenna pairs once position acquisition is achieved will greatly reduce computational overhead.

The uniqueness of the present invention is grounded in synchronization of the reference oscillators of the master and slave units, regardless of frequency, and in the use of thermally-insulated reference oscillators and phase-lock loops to establish and maintain phase coherency between master and slave units across all frequencies. In addition, the use of frequency hopping enables not only the random selection of low-noise channels, but also multipath data elimination, thereby provide high-resolution measurements with minimal bandwidth requirements.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. Those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A method for adjusting a synchronizing a local oscillator with an incoming signal, the method comprising:
reading a phase of an incoming signal in a phase measurement unit; and
controlling a DAC of an oscillator to change a phase of a signal, wherein the phase is adjusted until the local oscillator is synchronized with the phase of the incoming signal.

2. The method of claim 1, further comprising injecting an amount of energy into the control pin of the oscillator that generates a known phase-shift, wherein a frequency control and a phase control of the signal are decoupled.

3. The method of claim 1, further comprising injecting a variable amount of energy into the control pin of the oscillator that generates a variable phase-shift.

4. The method of claim 1, wherein the oscillator is digitally controlled.

5. The method of claim 1, wherein the oscillator is a numerically controlled oscillator.

6. The method of claim 1, wherein the oscillator has a slow frequency adjustment for changes in an environment of the oscillator.

7. The method of claim 1, wherein the oscillator is adjusted over multiple exchanges of information, and where the time between these exchanges is taken into account for phase correction.

8. The method of claim 1, wherein a phase of the signal is adjusted by extracting energy.

9. The method of claim 1, wherein the frequency of the signal is adjusted independently of the phase of the signal.

10. The method of claim 1, wherein controlling a DAC of an oscillator includes injecting or extracting a fixed amount of every above an average oscillator control.

11. The method of claim 1, wherein controlling a DAC of an oscillator includes injecting or extracting a variable amount of energy abo the average oscillator control.

12. A device configured to synchronize a local oscillator with an incoming signal, the device comprising:
a phase management unit configured to compare a phase of an incoming signal with a phase of a local oscillator;
a microcontroller configured to adjust the phase of the local oscillator until the local oscillator is synchronized with the phase of the incoming signal.

13. The device of claim 12, further comprising:
a digital to analog converter;
a local voltage controlled oscillator;
a high-frequency voltage controlled oscillator;
a phase locked loop; and
a microcontroller configured to adjust the digital to analog converter to inject or extract energy into the local voltage controlled oscillator, which results in a phase change in the high-frequency voltage controlled oscillator.

14. The device of claim 12, wherein the local voltage oscillator and the high-frequency voltage controlled oscillator are digitally controlled.

15. The device of claim 12, wherein the local voltage controlled oscillator and the high-frequency voltage controlled oscillator are numerically controlled oscillators.

16. The device of claim 12, wherein the local voltage controlled oscillator and the high-frequency voltage controlled oscillator each have a slow frequency adjustment for a change in temperature

17. The device of claim 1, where the local voltage controlled oscillator is adjusted over multiple exchanges of information, and where the time between these exchanges is taken into account for phase correction.

18. The device of claim 12, wherein each injection or extraction of energy includes a bolus, wherein a number of boluses executed over a time period indicates a frequency drift between the high-frequency voltage controlled oscillator and a high-frequency voltage controlled oscillator of a second device, where the number of boluses is used to adjust an average oscillator control.

19. A method for adjusting an oscillator, the method comprising:
adjusting a phase of an oscillator using a pulse of adjustable amplitude and/or width with a pulse adjustment; and
adjusting a frequency of the oscillator using a mean voltage, wherein the phase and the frequency are adjusted independently.

20. The method of claim 19, further comprising synchronizing the local oscillator to an incoming signal by reading a phase of the incoming signal in a phase measurement unit and adjusting the phase with the pulse adjustment.

21. The method of claim 20, further comprising measuring a frequency offset from the incoming signal by two or more phase measurements and then adjusting the phase of the oscillator using the pulse adjustment.
